(19) United States
(12) Patent Application Publication
(10) Pub. No.: US 2026/0063861 A1
(43) Pub. Date: Mar. 5, 2026

(54) OPTICAL-ELECTRICAL INTEGRATED DEVICE

(71) Applicant: SHINKO ELECTRIC INDUSTRIES CO., LTD., Nagano (JP)

(72) Inventors: Hisashi KANEDA, Nagano (JP); Takashi OZAWA, Nagano (JP); Yasushi ARAKI, Nagano (JP); Tomoharu FUJII, Nagano (JP)

(21) Appl. No.: 19/312,968

(22) Filed: Aug. 28, 2025

(30) Foreign Application Priority Data
Sep. 2, 2024 (JP) 2024-150988

(51) Int. Cl. G02B 6/43; G02B 6/42

(52) U.S. Cl. CPC G02B 6/43; G02B 6/4249; G02B 6/428

(57) ABSTRACT

includes a first wiring board, a plurality of second wiring boards, each second wiring board of the plurality of second wiring board being equipped with an integrated circuit, and an optical waveguide board. The plurality of second wiring boards and the optical waveguide board are disposed at different positions on an upper surface of the first wiring board in a plan view, and each second wiring board is optically connected to optical waveguide board.

### CROSS-REFERENCE TO RELATED APPLICATIONS

This application is based upon and claims priority to Japanese Patent Application No. 2024-150988, filed on Sep. 2, 2024, the entire contents of which are incorporated herein by reference.

### FIELD

Certain aspects of the embodiments discussed herein are related to optical-electrical integrated devices. The optical-electrical integrated devices are sometimes also referred to as optoelectronic hybrid modules.

### BACKGROUND

In the fields of information technology represented by the Internet, optical communication systems, or the like, optical signals are used in place of electrical signals as communication speeds increase. In such fields, it is necessary to convert optical signals to electrical signals, to convert electrical signals to optical signals, and to interconnect signals between wiring boards or circuit boards. For this reason, various optical interconnection structures have been proposed.

An example of the related art includes Japanese Laid-Open Patent Publication No. 2020-91303, for example.

### SUMMARY

It is an object in one aspect of the embodiments to provide an optical-electrical integrated device capable of interconnecting a plurality of wiring boards equipped with integrated circuits with low optical loss.

According to one aspect of the embodiments, an optical-electrical integrated device includes a first wiring board; a plurality of second wiring boards, each second wiring board of the plurality of second wiring board being equipped with an integrated circuit; and an optical waveguide board, wherein the plurality of second wiring boards and the optical waveguide board are disposed at different positions on an upper surface of the first wiring board in a plan view, and each second wiring board is optically connected to the optical waveguide board.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a perspective view illustrating an example of an optical-electrical integrated device according to an embodiment;

FIG. 2 is a cross sectional view illustrating the example of the optical-electrical integrated device according to the embodiment; and

FIG. 3 is a perspective view illustrating an example of connecting the optical-electrical integrated devices.

### DESCRIPTION OF EMBODIMENTS

Preferred embodiments of the present invention will be described with reference to the accompanying drawings. In the drawings, those constituent elements that are the same are designated by the same reference numerals, and a redundant description of the same parts may be omitted.

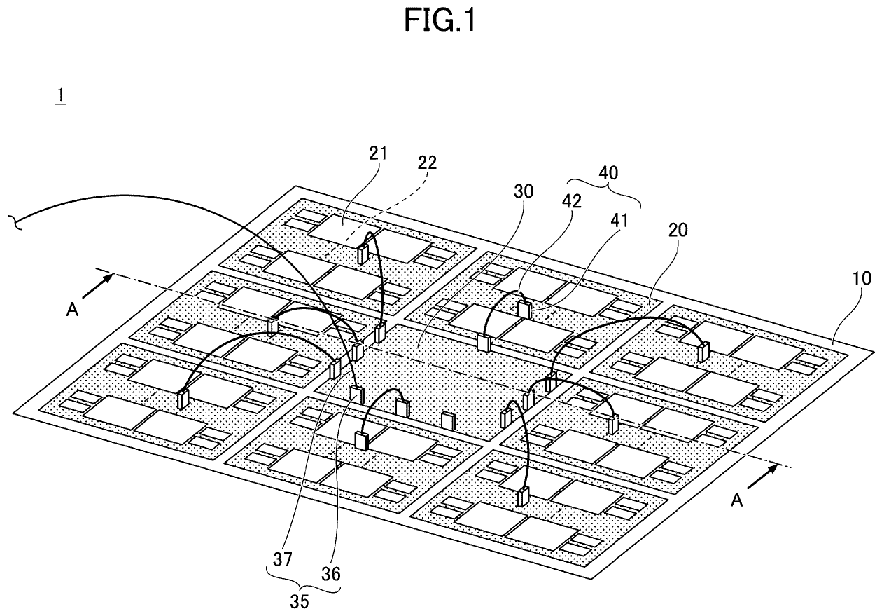

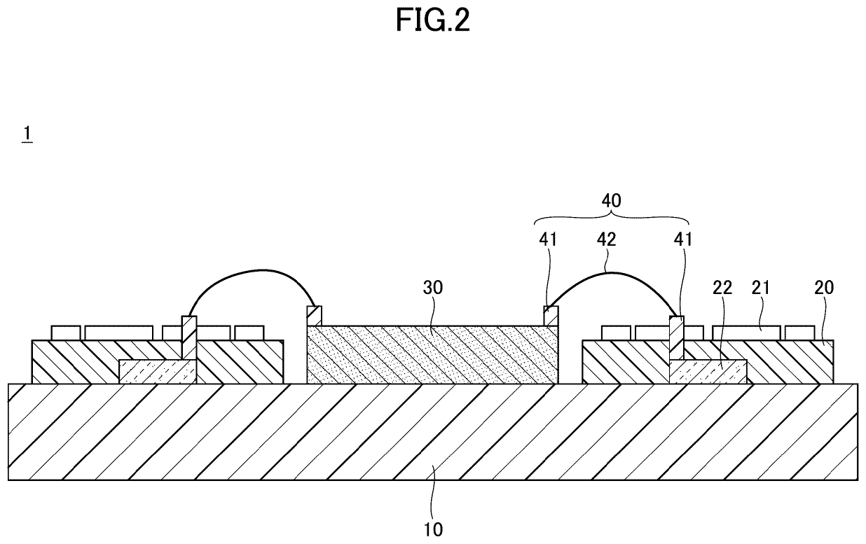

FIG. 1 is a perspective view illustrating an example of an optical-electrical integrated device according to an embodiment. FIG. 2 is a cross sectional view illustrating the example of the optical-electrical integrated device according to the embodiment.

As illustrated in FIG. 1 and FIG. 2, an optical-electrical integrated device 1 includes one first wiring board 10, eight second wiring boards 20, and one optical waveguide board 30. The number of the second wiring boards 20 and the optical waveguide boards 30 are not limited to the examples illustrated in FIG. 1 and FIG. 2, and the optical-electrical integrated device 1 may include a plurality of second wiring boards 20 and one or a plurality of optical waveguide boards 30 on the first wiring board 10. A minimum number of the second wiring boards 20 may be two.

The first wiring board 10 has a rectangular shape in a plan view, for example. The first wiring board 10 may have a square shape or a rectangular shape having one side in a range of approximately 200 mm to approximately 400 mm in the plan view, for example. The first wiring board 10 has a size larger than those of the second wiring board 20 and the optical waveguide board 30 in the plan view. The first wiring board 10 is a board formed with interconnects formed of copper or the like on a resin board, such as a glass epoxy board or the like, for example. The first wiring board 10 may be a multilayer wiring board. The first wiring board 10 is a motherboard, for example.

Each second wiring board 20 has a rectangular shape in the plan view, for example. Each second wiring board 20 is a board formed with interconnects formed of copper or the like on a resin board, such as a glass epoxy board or the like, for example. Each second wiring board 20 may be a glass board or a ceramic board. Each second wiring board 20 may be a multilayer wiring board. Each second wiring board 20 is electrically connected to the first wiring board 10 via bumps or the like.

Each second wiring board 20 is equipped with one or more integrated circuits 21. The integrated circuit 21 is flip-chip bonded on an interconnect disposed on an upper surface of the second wiring board 20, for example. Each second wiring board 20 may include an application specific integrated circuit (ASIC) or a memory as the integrated circuit 21, for example. In the illustrated example, each second wiring board 20 includes four ASICs, and two memories electrically connected to each of the four ASICs, but the present disclosure is not limited to the illustrated example.

Each second wiring board 20 is equipped with a photonic integrated circuit (PIC) 22. The PIC 22 may be embedded in the second wiring board 20, or may be flip-chip bonded on an interconnect disposed on the upper surface of the second wiring board 20, for example. The PIC 22 includes a board formed of silicon or the like equipped with an optical waveguide, a light emitting element, a light receiving element, or the like, for example. The PIC 22 may be referred to as silicon photonics or the like. The PIC 22 has a function of converting electrical signals to optical signals and vice versa. The PIC 22 is electrically connected to one or more integrated circuits 21.

The optical waveguide board 30 has a rectangular shape in the plan view, for example. The optical waveguide board 30 includes a base material, and an optical waveguide formed on the base material. The optical waveguide board 30 is not equipped with an integrated circuit or a PIC. The optical waveguide may be embedded in the base material constituting the optical waveguide board 30, or may be disposed on an upper surface of the base material, for example.

Examples of the base material include silicon, glass, resins, or the like, for example. Examples of the optical waveguide include a silicon nitride optical waveguide, a glass optical waveguide, a silicon optical waveguide, a polymer optical waveguide, or the like, for example. Among these examples of the optical waveguide, the optical waveguide board 30 preferably includes a silicon nitride optical waveguide with low optical loss.

Each second wiring board 20 and the optical waveguide board 30 are disposed at different positions on the upper surface of the first wiring board 10 in the plan view. Each second wiring board 20 and the optical waveguide boards 30 do not overlap each other in the plan view. Each second wiring board 20 and the optical waveguide boards 30 have rectangular shapes with identical sizes in the plan view, for example.

In this case, each second wiring board 20 and the optical waveguide board 30 can be arranged in a matrix on the upper surface of the first wiring board 10 in the plan view, for example. Accordingly, it is possible to shorten connection paths (or interconnects) between each second wiring board 20 and the optical waveguide board 30, because each second wiring board 20 and the optical waveguide board 30 can be efficiently arranged on the upper surface of the first wiring board 10. In the illustrated example, each second wiring board 20 and the optical waveguide board 30 are arranged in a matrix of three rows and three columns on the upper surface of the first wiring board 10 in the plan view.

Each second wiring board 20 is optically connected to the optical waveguide board 30.

Specifically, the PIC 22 provided on each second wiring board 20 is electrically connected to the integrated circuit 21 provided on the same second wiring board 20, and is optically connected to the optical waveguide of the optical waveguide board 30. That is, the PIC 22 converts electrical signals from the integrated circuit 21 to optical signals, and sends the optical signals to the optical waveguide of the optical waveguide board 30. In addition, the PIC 22 converts optical signals from the optical waveguide of the optical waveguide board 30 to electrical signals, and sends the electrical signals to the integrated circuit 21.

In a case where the optical-electrical integrated device 1 includes a plurality of optical waveguide boards 30, each second wiring board 20 is optically connected to one of the optical waveguide boards 30. One second wiring board 20 may be optically connected to a plurality of optical waveguide boards 30.

The optical waveguide of the optical waveguide board 30 and the PIC 22 of the second wiring board 20 can be optically connected via an optical coupling member (or an optical interface component) 40. The optical coupling member 40 may include a grating coupler 41 and a fiber array 42, for example. The optical coupling member 40 may include an edge coupler in place of the grating coupler 41, for example. The optical waveguide of the optical waveguide board 30 and the PIC 22 of the second wiring board 20 may be optically connected without the optical coupling member 40. In addition, a portion where the optical waveguide of the optical waveguide board 30 and the PIC 22 of the second wiring board 20 are optically connected via the optical coupling member 40 and a portion where the optical waveguide of the optical waveguide board 30 and the PIC 22 of the second wiring board 20 are optically connected without the optical coupling member 40 may coexist. Further, the optical waveguide of the optical waveguide board 30 and the PIC 22 of the second wiring board 20 can be optically connected via adiabatic coupling, for example. In this case, the fiber array 42 may be omitted. As described above, there are various methods for optically connecting the optical waveguide of the optical waveguide board 30 and the PIC 22 of the second wiring board 20, and among the various methods, it is preferable to optically connect the optical waveguide and the PIC 22 via an edge coupler with low optical loss.

In the case where the optical-electrical integrated device 1 includes one optical waveguide board 30, the second wiring boards 20 are preferably arranged radially around the optical waveguide board 30 in the plan view. According to such an arrangement, the connection path between each second wiring board 20 and the optical waveguide board 30 can be shortened, and the interconnection can be achieved with low optical loss.

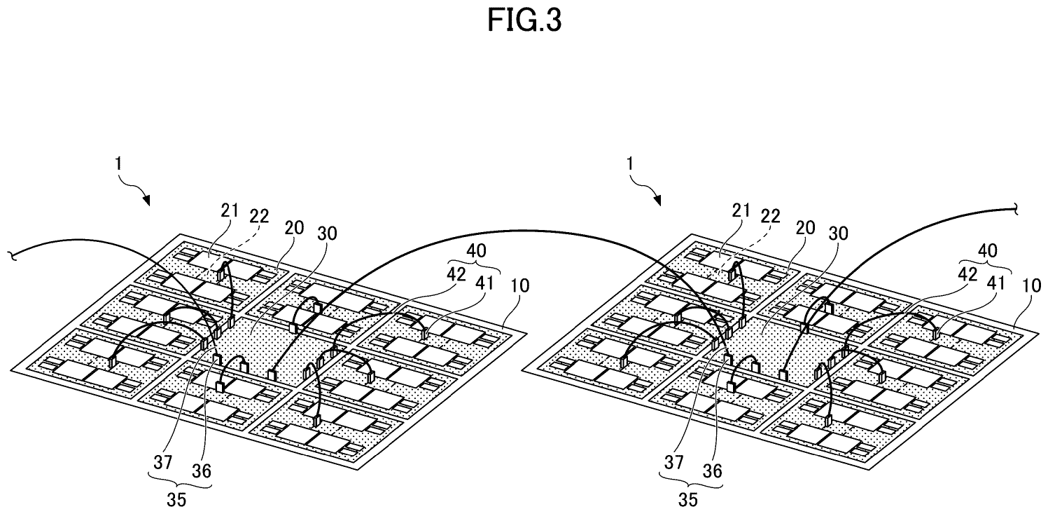

FIG. 3 is a perspective view illustrating an example of connecting the optical-electrical integrated devices. As illustrated in FIG. 1 and FIG. 3, in the optical-electrical integrated device 1, the optical waveguide board 30 has an input/output device 35 for optically connecting the optical-electrical integrated device 1 to an external component. The input/output device 35 may include a grating coupler 36 and a fiber array 37, for example. An edge coupler may be used in place of the grating coupler 36. The edge coupler is preferable in that the edge coupler has a lower optical loss than the grating coupler 36. The input/output device 35 may be used for connecting the optical-electrical integrated devices 1 to each other as illustrated in FIG. 3, or may be used for connecting the optical-electrical integrated device 1 to another board.

As described above, in the optical-electrical integrated device 1, one or more optical waveguide boards 30 are provided to relay the second wiring board 20, and each second wiring board 20 is optically connected to one of the optical waveguide boards 30. For example, if the second wiring boards 20 were optically connected without providing the optical waveguide board 30, the fibers would become long or the fibers would cross each other, thereby making the optical coupling difficult and making a low-loss optical coupling difficult to achieve. In contrast, by relaying the optical signals from the respective second wiring boards 20 via the optical waveguide board 30, the optical coupling between the second wiring boards 20 becomes easy to achieve, thereby making it possible to interconnect the second wiring boards 20 with low optical loss.

According to the disclosed technology, it is possible to provide an optical-electrical integrated device capable of interconnecting a plurality of wiring boards equipped with integrated circuits with low optical loss.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. An optical-electrical integrated device comprising:
a first wiring board;
a plurality of second wiring boards, each second wiring board of the plurality of second wiring board being equipped with an integrated circuit; and
an optical waveguide board, wherein:
the plurality of second wiring boards and the optical waveguide board are disposed at different positions on an upper surface of the first wiring board in a plan view, and
each second wiring board is optically connected to the optical waveguide board.

2. The optical-electrical integrated device as claimed in claim 1, wherein:
each second wiring board is equipped with a photonic integrated circuit,
the photonic integrated circuit has functions of converting an electrical signal to an optical signal and converting an optical signal to an electrical signal, and
the photonic integrated circuit is electrically connected to the integrated circuit and is optically connected to the optical waveguide board.

3. The optical-electrical integrated device as claimed in claim 2, wherein an optical waveguide of the optical waveguide board and the photonic integrated circuit are optically connected via an edge coupler.

4. The optical-electrical integrated device as claimed in claim 1, wherein the optical waveguide board includes a silicon nitride optical waveguide.

5. The optical-electrical integrated device as claimed in claim 1, wherein the optical waveguide board has an input/output device configured to optically connect the optical-electrical integrated device to an external component.

6. The optical-electrical integrated device as claimed in claim 1, wherein:
the plurality of second wiring boards and the optical waveguide board have rectangular shapes with identical sizes in the plan view, and
the plurality of second wiring boards and the optical waveguide board are arranged in a matrix on the upper surface of the first wiring board in the plan view.

7. The optical-electrical integrated device as claimed in claim 1, wherein the plurality of second wiring boards are arranged radially around the optical waveguide board in the plan view.

8. The optical-electrical integrated device as claimed in claim 1, further comprising:
at least one optical waveguide board, other than the optical waveguide board, provided on the upper surface of the first wiring board and forming a plurality of optical waveguide boards together with the optical waveguide board,
wherein the plurality of second wiring boards and the plurality of optical waveguide boards are disposed at different positions on the upper surface of the first wiring board in the plan view.

9. The optical-electrical integrated device as claimed in claim 8, wherein:
the plurality of second wiring boards and the plurality of optical waveguide boards have rectangular shapes with identical sizes in the plan view, and
the plurality of second wiring boards and the plurality of optical waveguide boards are arranged in a matrix on the upper surface of the first wiring board in the plan view.

10. The optical-electrical integrated device as claimed in claim 8, wherein each second wiring board of the plurality of second wiring boards is optically connected to one optical waveguide board of the plurality of optical waveguide boards.
